(19) United States
(12) Patent Application Publication
(10) Pub. No.: US 2022/0106923 A1
(43) Pub. Date: Apr. 7, 2022

(54) CYLINDER LINER

(71) Applicant: Caterpillar Inc., Peoria, IL (US)

(72) Inventors: Shu Zhang, Dunlap, IL (US); Miguel M. Cervantes, Peoria, IL (US); Scott David Perkins, Mapleton, IL (US); Andrew James Cummins, West Lafayette, IN (US)

(73) Assignee: Caterpillar Inc., Peoria, IL (US)

(21) Appl. No.: 17/064,810

(22) Filed: Oct. 7, 2020

(51) Int. Cl. F02F 1/00; F02F 7/00; F02F 1/24; F02F 1/42; F02F 3/00; F16C 3/10

(52) U.S. Cl. CPC F02F 1/004; F02F 7/0043; F02F 1/242; F16F 15/283; F02F 3/00; F16C 3/10; F02F 1/4285

(57) ABSTRACT

An annular cylinder liner includes an annular body defining a longitudinal axis, a radial direction perpendicular to the longitudinal axis, a circumferential direction, a first longitudinal end, a second longitudinal end, and a liner length measured from the first longitudinal end to the second longitudinal end along the longitudinal axis. The annular body also includes a shoulder that is disposed at the first longitudinal end, defining a shoulder axial thickness measured along the longitudinal axis. A ratio of the liner length to the shoulder axial thickness ranges from 24.0 to 46.0.

### TECHNICAL FIELD

The present disclosure relates generally to cylinder liners that are used in internal combustion engines having a piston that slides back and forth within the cylinder liner. More specifically, the present disclosure relates to a cylinder liner that allows for proper clearance when other engine components with altered geometry are employed.

### BACKGROUND

Internal combustion engines are routinely used in various industries to power machines and equipment. Examples of industries using such machines and equipment include marine, earth moving, construction, mining, locomotive and agriculture industries, etc. In certain markets and market segments, internal combustion engines that require less maintenance and/or that provide more power are desired.

More specifically, it often necessary to replace various engine components including cylinder liners since as they wear, problems with the engine may occur. In compression ignition engines, more power may be desired that may lead to altered engine components. As a result, clearances may be adjusted due to avoid possible interference or even crashing of one component to another in operation. Moreover, altering the geometry of engine components may affect the stackups and clearances between various other components requiring further geometric adjustments.

### SUMMARY OF THE DISCLOSURE

An internal combustion engine according to an embodiment of the present disclosure may comprise a crankcase defining an interior cavity and a cylinder bore that extends from the interior cavity defining a longitudinal axis, a radial direction, a circumferential direction, and forming a junction with the interior cavity. A crankshaft may be disposed in the interior cavity of the crankcase defining an axis of rotation, and an annular cylinder liner may be disposed in the cylinder bore. A piston may be disposed in the annular cylinder liner, while a connecting rod is connected to the piston, extending from the cylinder bore to the interior cavity, and is also connected to the crankshaft. A cylinder head may be attached to the crankcase including an air inlet passage, and an exhaust conduit. The engine may also define a crank angle in a plane containing the longitudinal axis, and the radial direction that is measured from the longitudinal axis about the axis of rotation to a datum line that passes through the axis of rotation, and the crank throw center that ranges from 233.0 degrees to 237.0 degrees.

A crankshaft according to an embodiment of the present disclosure comprises a body defining an axis of rotation, and a radial direction. The crankshaft further comprises at least one crank throw including a crank pin that is configured to be attached to a connecting rod, and at least one counterweight that includes an outer circumferential surface that is disposed at a radial extremity of the body. The outer circumferential surface may include a first arcuate surface that is spaced away a first radial distance from the axis of rotation that ranges from 160.0 mm or less in a plane containing the radial direction.

An annular cylinder liner according to an embodiment of the present disclosure may comprise an annular body defining a longitudinal axis, a radial direction perpendicular to the longitudinal axis, a circumferential direction, a first longitudinal end, a second longitudinal end, and a liner length measured from the first longitudinal end to the second longitudinal end along the longitudinal axis. The annular body may include a shoulder that is disposed at the first longitudinal end, defining a shoulder axial thickness measured along the longitudinal axis. A ratio of the liner length to the shoulder axial thickness may range from 24.0 to 46.0.

### BRIEF DESCRIPTION OF THE DRAWINGS

FIG. 1 is a perspective view of an internal combustion engine that may employ a cylinder liner and a crankcase according to various embodiments of the present disclosure.

FIG. 2 is a side sectioned schematic view of the engine of FIG. 1, illustrating in general terms the functioning components of the engine.

FIG. 3 is a sectioned rear view of the internal combustion engine of FIG. 1, showing in more operating detail a cylinder liner and a crankcase according to various embodiments of the present disclosure that are disposed next to each other where the cylinder bore extends to the interior cavity of the crankcase.

FIG. 4 is an enlarged sectioned front view of the cylinder liner and piston of FIG. 3, illustrating the reciprocating movement of the piston in the cylinder liner in the cylinder bore of the engine.

FIG. 5 is a perspective view of the cylinder liner of FIGS. 3 thru 5, shown in isolation with enhanced detail.

FIG. 6 is a front view of the cylinder liner of FIG. 6.

FIG. 7 is sectioned front view of the engine showing the crankshaft approaching the piston and cylinder liner in operation. The curvature of the outer circumferential surfaces are depicted. The crank angle at which the minimum clearance is present between the crankshaft and the cylinder liner is shown.

FIG. 8 is an enlarged sectioned front detail view of the crankcase of FIG. 7 showing more clearly the clearance that may be provided between the crankshaft and the cylinder liner.

FIG. 9 is an enlarged perspective view of the crankshaft of FIG. 8, more clearly showing the two outer circumferential surfaces.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or a prime indicator such as 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters or primes will often not be included herein but may be shown in the drawings to indicate duplications of features discussed within this written specification.

Various embodiments of a cylinder liner and/or a crankcase that may be used in an internal combustion engine according to principles of the present disclosure will now be described. More particularly, the crankcase may have geometrical changes at the junction of the cylinder bore and interior cavity where the crank shaft is disposed, necessitating geometrical changes to the cylinder liner in order to provide proper clearance between the connecting rod and the crankcase.

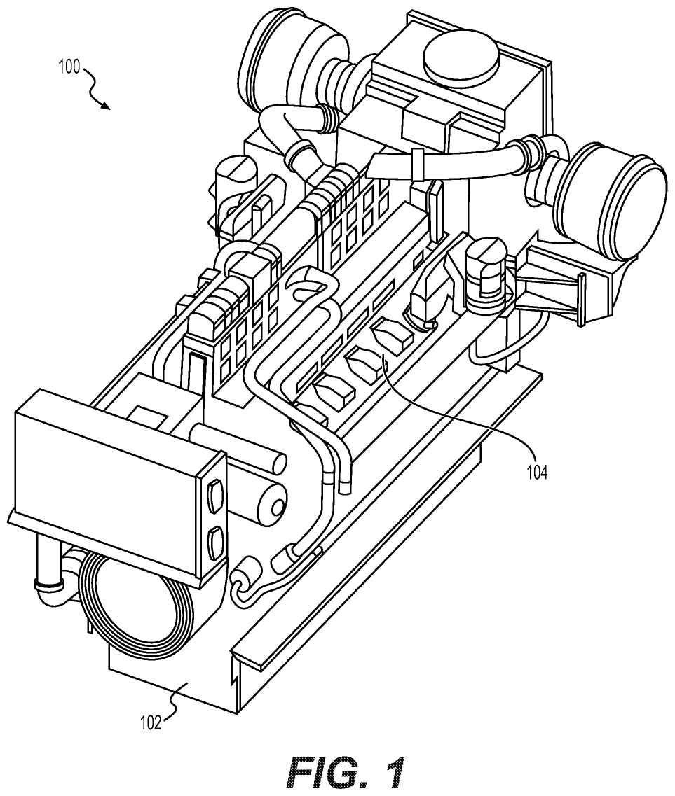

For example, an internal combustion engine 100 is shown in FIG. 1 that may employ various embodiments of the cylinder liner and crankcase constructed according to the principles set forth herein. The engine 100 may include an engine block 102 (or the crankcase) in which the piston (not shown) reciprocates, and a cylinder head 104 that may contain various engine components for the introduction of fluids into the bore/combustion chamber located in the engine block 102.

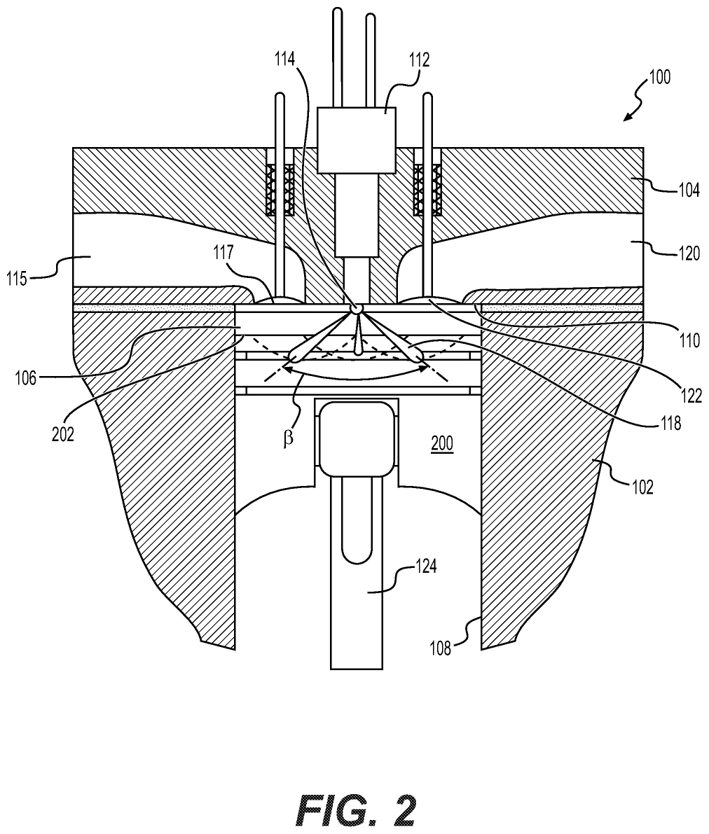

Turning to FIG. 2, a portion of the engine 100 is shown sectioned, revealing the combustion chamber 106 that may have a generally cylindrical shape that is defined within a cylinder bore 108 formed within the crankcase or engine block 102 of the engine 100. The combustion chamber 106 is further defined at one end by a flame deck surface 110 of the cylinder head 104, and at another end by a crown portion 126 of a piston 128 that is reciprocally disposed within the bore 108, and is connected to a connecting rod 124, which in turn is connected to a crank shaft (not shown in FIG. 2). A fuel injector 112 is mounted in the cylinder head 104. The injector 112 has a tip 114 that protrudes within the combustion chamber 106 through the flame deck surface 110 such that it can directly inject fuel into the combustion chamber 106.

During operation of the engine 100, air is admitted into the combustion chamber 106 via an air inlet passage 115 when one or more intake valves 117 (one shown) are open during an intake stroke. In a known configuration, high pressure fuel is permitted to flow through nozzle openings in the tip 114 to form fuel jets that enter the combustion chamber 106. Each nozzle opening creates a fuel jet 118 that generally disperses to create a predetermined fuel/air mixture, which in a compression ignition engine auto-ignites and combusts. The fuel jets 118 may be provided from the injector at an included angle β of between 110 and 150 degrees, but other angles may also be used. Following combustion, exhaust gas is expelled from the combustion chamber through an exhaust conduit 120 when one or more exhaust valves 122 (one shown) is/are open during an exhaust stroke.

The uniformity and extent of fuel/air mixing in the combustion cylinder is relevant to the combustion efficiency as well as to the amount and type of combustion byproducts that are formed. For example, fuel-rich mixtures, which may be locally present within the combustion chamber 106 during a combustion event due to insufficient mixing, may lead to higher soot emissions and lower combustion efficiency.

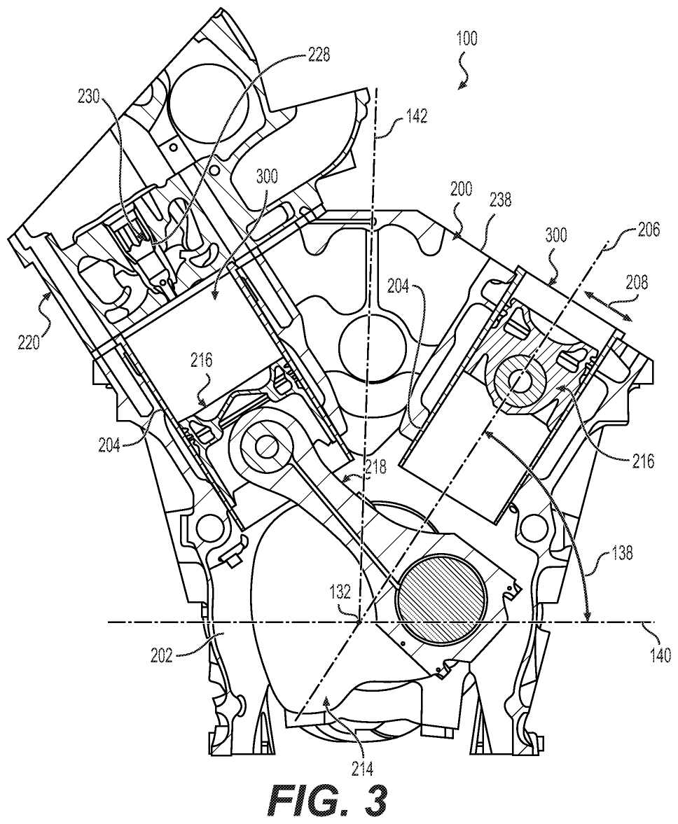

Referring now to FIG. 3, a further details of the engine 100 of FIG. 1 will now be discussed. The engine may include a crankcase 200 defining an interior cavity 202, and a cylinder bore 204 that extends from the interior cavity 202 at a 60 degree angle 138 (+/−5 degrees) from the horizontal axis 140. So, a “V” engine is shown in FIG. 3 with a plurality of cylinders forming a V shape about a vertical plane 142 situated half way horizontally between the cylinders. Other configurations are possible in other embodiments of the present disclosure including inline. All the cylinders and their respective components may be similarly or identically configured to each other in some embodiments of the present disclosure.

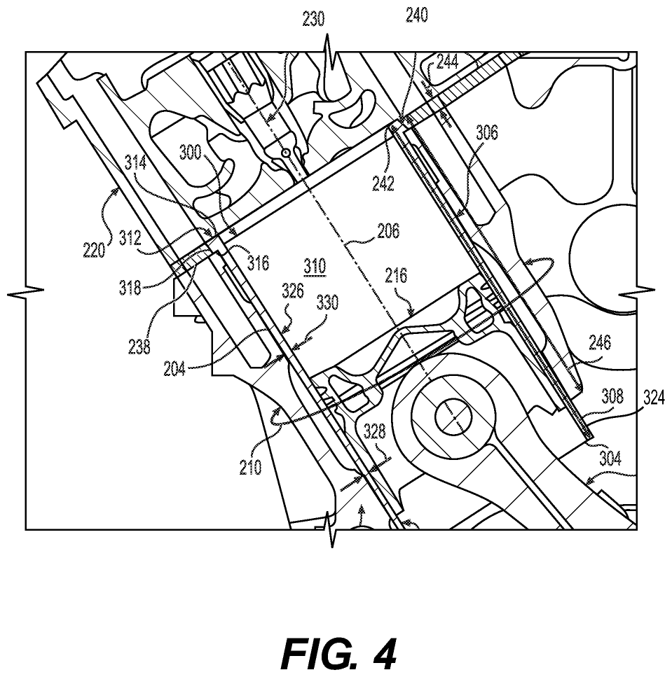

The cylinder bore 204 may define a longitudinal axis 206, a radial direction 208, and a circumferential direction 210 (see FIG. 4), and forming a junction with the interior cavity 202. That is to say, the cylinder bore is in communication with the interior cavity.

Looking at FIGS. 3 and 4 together, a crankshaft 214 is typically disposed in the interior cavity 202 of the crankcase 200, while an annular cylinder liner 300 is typically disposed in the cylinder bore 204. Also, the piston 216 is typically disposed in the annular cylinder liner 300 for reciprocating movement in the liner. A connecting rod 218 is connected to the piston 216, extending from the cylinder bore 204 to the interior cavity 202. The connecting rod 218 is also connected to the crankshaft 214. The cylinder head 220 is attached to the crankcase 200. A fuel injector bore 228 having a fuel injector 230 disposed therein may also be provided. In other embodiments, a carburetor and a spark plug may be employed instead of a fuel injector, etc.

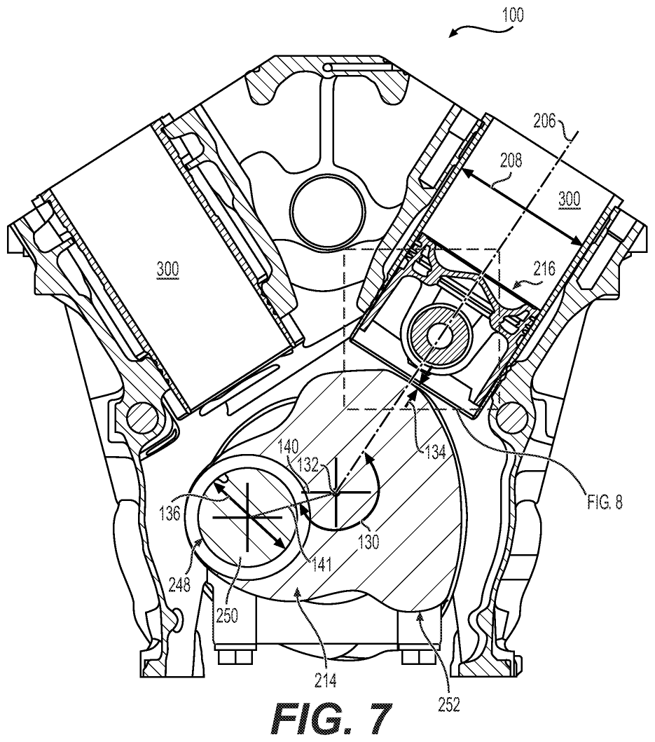

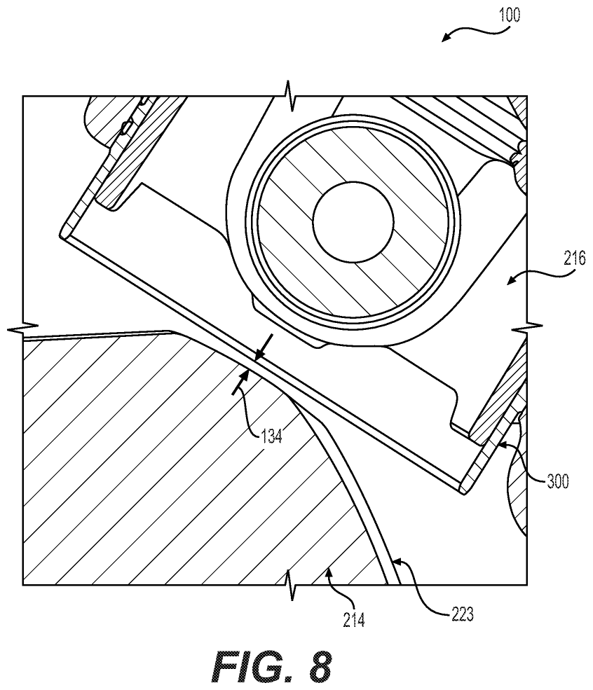

Focusing on FIGS. 7 and 8, the engine 100 may define a crank angle 130 in a plane containing the longitudinal axis 206, and the radial direction 208 that is measured from the longitudinal axis 206, which is where the minimum clearance 134 occurs between the crankshaft and the annular cylinder liner, about the axis of rotation 132 to a datum line 141 that passes through the axis of rotation 132 (of the crankshaft 214), and the crank throw center that ranges from 200.0 degrees to 270.0 degrees. The crank angle 130 may range from 233.0 degrees to 237.0 degrees in certain embodiments (e.g. 235.0 degrees).

Also, the crankshaft 214 may define an outer circumferential surface 223 that includes an arcuate surface that may also define the minimum clearance 134 (see FIG. 8) between the crankshaft 214 and the annular cylinder liner 300. This minimum clearance may range from 1.0 mm to 25.0 mm in various embodiments of the present disclosure. Any of these dimensions may be different in other embodiments of the present disclosure.

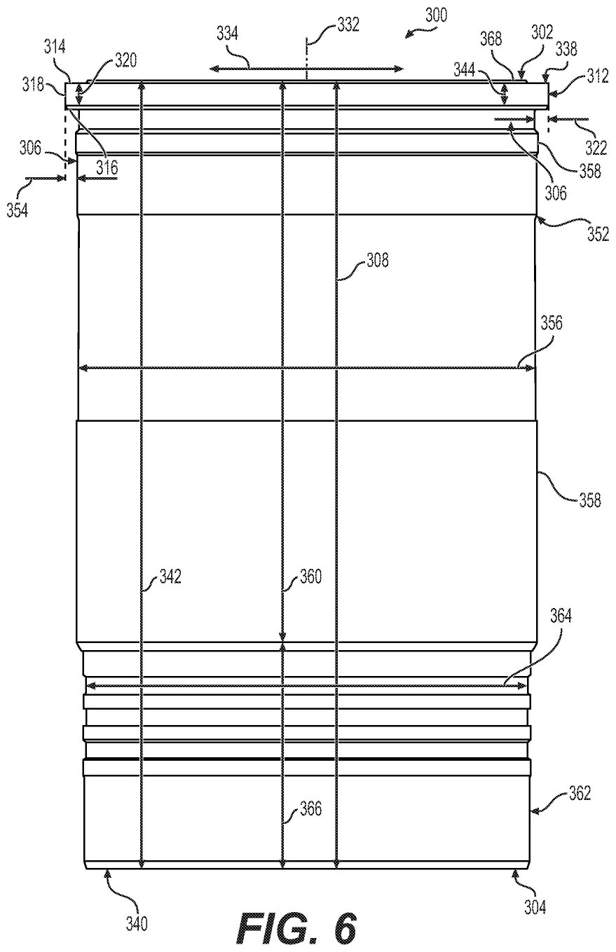

Looking at FIG. 6, the annular cylinder liner 300 may define a first axial end 302, and a second axial end 304 disposed along the longitudinal axis 206. The liner may also include an outer circumferential surface 306 that extends from the first axial end 302 to the second axial end 304, and further defines an overall longitudinal length 308 measured along the longitudinal axis 206 from the first axial end 302 to the second axial end 304 ranging from 246.0 mm to 271.0 mm in certain embodiments. As will be described momentarily herein, the outer circumferential surface 306 may flare in and out radially to create one or more steps or rings on the outside of the liner. This may not be the case in other embodiments of the present disclosure. The annular cylinder liner 300 further defines an inner circumferential surface 310 that extends from the first axial end 302 to the second axial end 304. A shoulder 312 may be disposed at the first axial end 302.

More specifically, the shoulder 312 includes a top shoulder surface 314, a bottom shoulder surface 316, and a shoulder circumferential surface 318. The shoulder 312 also defines an axial thickness 320 (see FIG. 6) that is measured along the longitudinal axis 206 from the top shoulder surface 314 to the bottom shoulder surface 316 ranging from 6.0 mm to 12.0 mm, and a radial width 322 that is measured from the outer circumferential surface 306 to the shoulder circumferential surface 318 along the radial direction 208 ranging from 3.0 mm to 7.0 mm in some embodiments of the present disclosure.

Moreover as seen in FIG. 4, the annular cylinder liner 300 may include a radially thin portion 324 that is disposed at the second axial end 304 (see also FIG. 4), and a radially thick portion 326 that is disposed axially between the radially thin portion 324, and the shoulder 312. The radially thin portion 324 may define a thin radial thickness 328 that is measured along the radial direction 208 ranging from 3.0 mm to 6.0 mm, and the radially thick portion 326 may define a thick radial thickness 330 that is measured along the radial direction 208 ranging from 5.0 mm to 10.0 mm in some embodiments of the present disclosure.

As best seen in FIG. 4, the radially thin portion 324 extends into the interior cavity 202 of the crankcase 200. The shoulder may contact a shoulder counterbore in the crankcase as will be discussed momentarily.

A crankcase 200 that may be provided as a replacement part or a replacement subassembly will now be described with continued reference to FIG. 4. The body (e.g. a casting that is later machined) of the crankcase 200 may include a flat interface surface 238 that is intended to mate with the cylinder head 220. A shoulder counterbore 240 may extend from the flat interface surface 238 to a bottom counterbore surface 242 (may be planar and annular). The shoulder counterbore 240 is in communication with the cylinder bore 204, defining a shoulder counterbore depth 244 that is measured along the longitudinal axis 206 from the flat interface surface 238 to the bottom counterbore surface 242. This depth 244 may range from 9.0 mm to 12.0 mm in some embodiments of the present disclosure and a radial dimension that is greater than that of the shoulder of the annular cylinder liner. Also, the cylinder bore 204 defines a bore axial length 246 that is measured along the longitudinal axis 206 from the flat interface surface 238 to the interior cavity that ranges from 230.0 mm to 240.0 mm in some embodiments of the present disclosure.

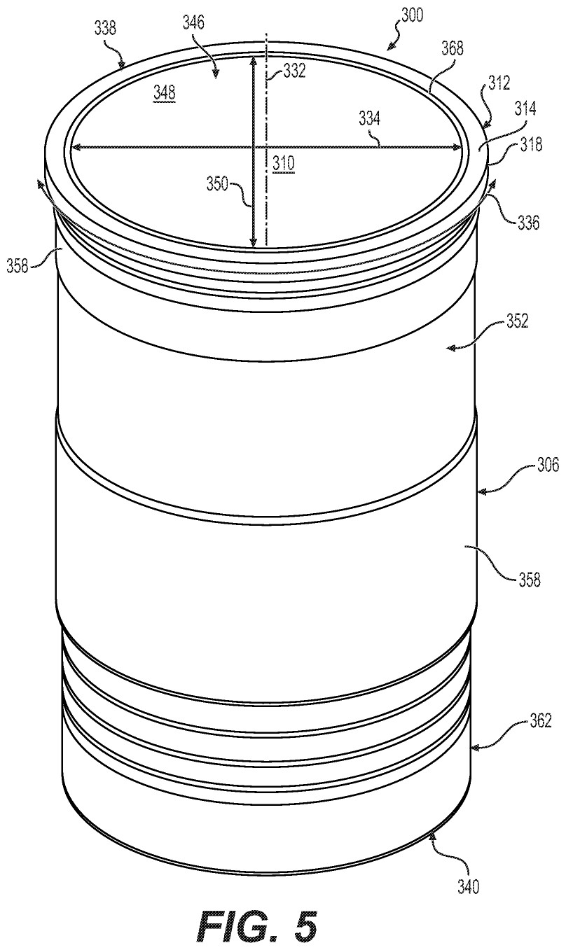

Next, an annular cylinder liner that may be provided as replacement part will be discussed with reference to FIGS. 5 and 6.

The annular cylinder liner 300 may comprise an annular body defining a longitudinal axis 332, a radial direction 334 that is perpendicular to the longitudinal axis 332, and a circumferential direction 336. Both a first longitudinal end 338, and a second longitudinal end 340 may be disposed along the longitudinal axis 332. In addition, a liner length 342 may be measured from the first longitudinal end 338 to the second longitudinal end 340 along the longitudinal axis 332. Likewise, an inner bore 346 may extend completely through from the first longitudinal end 338 to the second longitudinal end 340. In such a case, the inner bore 346 may define a continuous cylindrical surface 348 that extends from the first longitudinal end 338 to the second longitudinal end 340, defining an inner diameter 350 that ranges from 140.0 mm to 150.0 mm in some embodiments. This may not be the case in other embodiments of the present disclosure. Other ranges are possible in other embodiments of the present disclosure.

A shoulder 312 may be disposed at the first longitudinal end 338, defining a shoulder axial thickness 344 measured along the longitudinal axis 332. In some embodiments, a ratio of the liner length 342 to the shoulder axial thickness 344 may range from 27.0 to 32.0. In such a case, the shoulder axial thickness 344 may range from 6.0 mm to 12.0 mm, while the liner length 342 may range from 246.0 mm to 271.0 mm. Other ranges of ratios and dimensions may be employed in other embodiments of the present disclosure.

As alluded to earlier herein, an outer circumferential surface 306 may define a large diameter portion 352 that is disposed axially adjacent the shoulder 312, and the shoulder 312 protrudes a radial distance 354 measured along the radial direction 334 from the outer circumferential surface 306 that ranges from 2.0 mm to 5.0 mm in some embodiments.

For the embodiment shown in FIGS. 5 and 6, the large diameter portion 352 defines a varying large diameter 356 that ranges from 145.0 mm to 155.0 mm in some embodiments, forming a first plurality of steps or rings 358. A large diameter axial length 360 may be measured along the longitudinal axis 332 that ranges from 188.0 mm to 195.0 mm in some embodiments.

In addition, a small diameter portion 362 may extend from the large diameter portion 352 to the second longitudinal end 340. The large diameter axial length 360 would be measured along the longitudinal axis 332 from the shoulder 312 (i.e. the bottom shoulder surface) to the small diameter portion 362 in this embodiment. The small diameter portion 362 defines a varying small diameter 364 that ranges from 145.0 mm to 155.0 mm, and a small diameter portion axial length 366 that is measured along the longitudinal axis 332 from the large diameter portion 352 to the second longitudinal end 340 that ranges from 55.0 mm to 80.0 mm in some embodiments.

Hence, one skilled in the art may understand that the largest diameter of the small diameter portion is about the same as the smallest diameter of the large diameter portion, yielding the corresponding names of these portions of the liner.

A ridge 368 may also be disposed at the first longitudinal end 338 at the continuous cylindrical surface 348 and the top shoulder surface 314 in some embodiments.

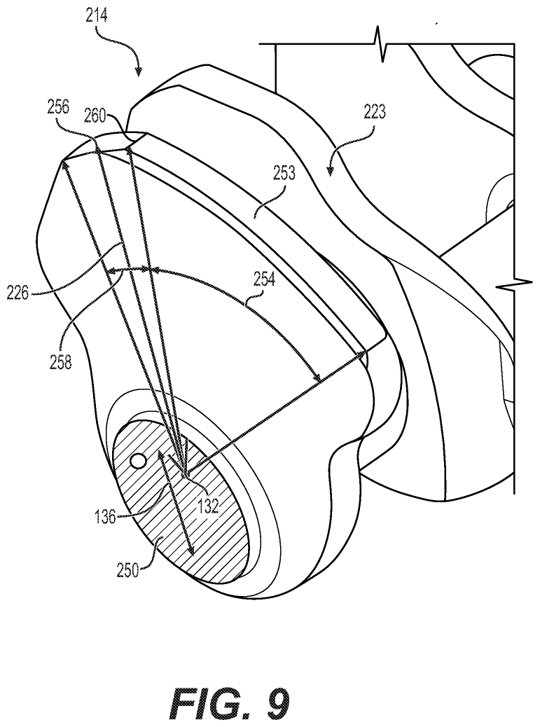

Next, a crankshaft 214 that may be provided as a replacement part will described with reference to FIGS. 7 and 9.

The crankshaft 214 may include a body defining an axis of rotation 132, and a radial direction 136. At least one crank throw 248 including a crank pin 250 that is configured to be attached to a connecting rod 218 may be provided. Also, at least one counterweight 252 may be provided that includes an outer circumferential surface 223 that is disposed at a radial extremity of the body.

The outer circumferential surface 223 may include a first arcuate surface 256 that is spaced away a first radial distance 226 (i.e. a dimension measured along the radial direction 136) from the axis of rotation 132 that ranges from 160.0 mm or less in a plane containing the radial direction 136 (and perpendicular to the axis of rotation 132, e.g. the sectioned plane of FIG. 9), and a second arcuate surface 253 that forms a cusp 260 with the first arcuate surface 256. Also, the first arcuate surface defines a circumferential extent 258 that is less than the circumferential extent 254 of the second arcuate surface 253.

As used herein, “circumferential surface” or “arcuate surface” includes any shape that is not straight or flat including a radius, an ellipse, a polynomial, a spline, etc.

The configuration and dimensional ranges of any of the embodiments discussed herein may be altered to be different depending on the application.

The crankcase may be made from grey cast iron or cast iron via a casting process and then have features machined. The cylinder liner and the crankshaft may be fabricated from steel, cast iron, or other suitable material that is durable, corrosion resistant, etc. The liner and crankshaft may also have features machined onto it. Suitable machining processes may include milling, turning, electrical discharge machining, etc.

### INDUSTRIAL APPLICABILITY

In practice, a cylinder liner, a crankcase, a crankshaft, and/or an engine assembly using such a cylinder liner or a crankcase or a crankshaft according to any embodiment described herein may be provided, sold, manufactured, and bought etc. as needed or desired in an aftermarket or OEM (original equipment manufacturer) context. For example, a crankcase or a cylinder liner may be used to retrofit an existing engine already in the field or may be sold with an engine or a piece of equipment using that engine at the first point of sale of the piece of equipment.

Appropriate clearances between the various components including the connecting rod, the crankcase, the crankshaft, and the cylinder liner may be provided by the embodiments disclosed herein. This may reduce the need for maintenance for the engine.

Accordingly, the geometry for both the crankshaft and the cylinder liner needed to be adjusted. However, these components still need to be durable enough to still work properly and satisfy other engine performances. Specifically, the length of the liner was reduced by 5.4 mm. However, the liner cannot be too short, or it can affect the piston dynamics as the engine operates. The dimensions and ratios given herein for various embodiments of the liner and the crankcase balance these various desired performances.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An annular cylinder liner comprising:
an annular body defining a longitudinal axis, a radial direction perpendicular to the longitudinal axis, a circumferential direction, a first longitudinal end, a second longitudinal end, and a liner length measured from the first longitudinal end to the second longitudinal end along the longitudinal axis, the annular body including
a shoulder that is disposed at the first longitudinal end, defining a shoulder axial thickness measured along the longitudinal axis; and
wherein a ratio of the liner length to the shoulder axial thickness ranges from 24.0 to 46.0, and the annular cylinder liner further includes a radially thin portion disposed at the second longitudinal end, the radially thin portion defining a thin radial thickness measured along the radial direction ranging from 3.0 mm to 5.0 mm, and the annular body lacks internal voids.

2. The annular cylinder liner of claim 1 wherein the shoulder axial thickness ranges from 6.0 mm to 12.0 mm.

3. The annular cylinder liner of claim 1 wherein the liner length ranges from 246.0 mm to 271.0 mm.

4. The annular cylinder liner of claim 1 further including an outer circumferential surface that defines a large diameter portion disposed axially adjacent the shoulder, and the shoulder protrudes a radial distance measured along the radial direction from the outer circumferential surface that ranges from 3.0 mm to 7.0 mm.

5. The annular cylinder liner of claim 1 further defining an inner bore that extends from the first longitudinal end to the second longitudinal end.

6. The annular cylinder liner of claim 5 wherein the inner bore defines a continuous cylindrical surface that extends from the first longitudinal end to the second longitudinal end, defining an inner diameter that ranges from 140.0 mm to 150.0 mm.

7. The annular cylinder liner of claim 1 wherein the large diameter portion defines a varying large diameter that ranges from 150.0 mm to 160.0 mm, forming a first plurality of steps or rings, and a large diameter axial length measured along the longitudinal axis that ranges from 188.0 mm to 195.0 mm.

8. The annular cylinder liner of claim 7 further comprising a small diameter portion that extends from the large diameter portion to the second longitudinal end, the large diameter axial length being measured along the longitudinal axis from the shoulder to the small diameter portion, the small diameter portion defining a varying small portion diameter that ranges from 145.0 mm to 155.0 mm, forming a second plurality of steps or rings, and a small diameter portion axial length measured along the longitudinal axis from the large diameter portion to the second longitudinal end that ranges from 55.0 mm to 80.0 mm.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An annular cylinder liner comprising:
an annular body defining a longitudinal axis, a radial direction perpendicular to the longitudinal axis, a circumferential direction, a first longitudinal end, a second longitudinal end, and a liner length measured from the first longitudinal end to the second longitudinal end along the longitudinal axis, the annular body including
a shoulder that is disposed at the first longitudinal end, defining a shoulder axial thickness measured along the longitudinal axis; and
the annular cylinder liner further include a radially thin portion disposed at the second longitudinal end, the radially thin portion defining a thin radial thickness measured along the radial direction ranging from 3.0 mm to 5.0 mm;
wherein the annular body lacks an internal water jacket void.

22. The annular cylinder liner of claim 21 wherein a ratio of the liner length to the shoulder axial thickness ranges from 24.0 to 46.0.

23. The annular cylinder liner of claim 22 wherein the shoulder axial thickness ranges from 6.0 mm to 12.0 mm.

24. The annular cylinder liner of claim 23 wherein the liner length ranges from 246.0 mm to 271.0 mm.

25. The annular cylinder liner of claim 24 further including an outer circumferential surface that defines a large diameter portion disposed axially adjacent the shoulder, and the shoulder protrudes a radial distance measured along the radial direction from the outer circumferential surface that ranges from 3.0 mm to 7.0 mm.

26. The annular cylinder liner of claim 25 further defining an inner bore that extends from the first longitudinal end to the second longitudinal end.

27. An annular cylinder liner comprising:
an annular body lacking an internal water jacket void, and defining a longitudinal axis, a radial direction perpendicular to the longitudinal axis, a circumferential direction, a first longitudinal end, a second longitudinal end, and a liner length measured from the first longitudinal end to the second longitudinal end along the longitudinal axis, the annular body including
a shoulder that is disposed at the first longitudinal end, defining a shoulder axial thickness measured along the longitudinal axis; and
the annular cylinder liner further include a radially thin portion disposed at the second longitudinal end, the radially thin portion defining a thin radial thickness measured along the radial direction ranging from 3.0 mm to 5.0 mm, and the shoulder axial thickness ranges from 6.0 mm to 12.0 mm.

28. The annular cylinder liner of claim 27 further including an outer circumferential surface that defines a large diameter portion disposed axially adjacent the shoulder, and the shoulder protrudes a radial distance measured along the radial direction from the outer circumferential surface that ranges from 3.0 mm to 7.0 mm.

29. The annular cylinder liner of claim 28 wherein a ratio of the liner length to the shoulder axial thickness ranges from 24.0 to 46.0.

30. The annular cylinder liner of claim 29 wherein the liner length ranges from 246.0 mm to 271.0 mm.

31. The annular cylinder liner of claim 30 further defining an inner bore that extends from the first longitudinal end to the second longitudinal end.
